(19) United States
(12) Patent Application Publication
(10) Pub. No.: US 2012/0039336 A1
(43) Pub. Date: Feb. 16, 2012

(54) High Performance, High Bandwidth Network Operating System

(76) Inventors: Alfred Richmond, Severna Park, MD (US); Peter W. Rung, Lutz, FL (US); David J. Boubion, Tampa, FL (US)

(21) Appl. No.: 12/673,450

(22) PCT Filed: Aug. 14, 2008
(86) PCT No.: PCT/US08/09737

§ 371 Date: Oct. 19, 2011

Related U.S. Application Data
(60) Provisional application No. 60/964,909, filed on Aug. 14, 2007.

(51) Int. Cl. H04L 12/28

(52) U.S. Cl. 370/392

(57) ABSTRACT

The present subject matter relates to computer operating systems, network interface cards and drivers, CPUs, random access memory and high bandwidth speeds. More specifically, a Linux operating system has specially-designed stream buffers, polling systems interfacing with network interface cards and multiple threads to deliver high performance, high bandwidth packets through the kernel to applications. A system and method are provided for capturing, aggregating, pre- analyzing and delivering packets to user space within a kernel to be primarily used by intrusion detection systems at multi-gigabit line rate speeds.

### TECHNICAL FIELD

The present subject matter generally relates to computer operating systems, network interface cards and drivers, CPU (central processing units), random access memory and high bandwidth speeds. More specifically, the present invention relates to a Linux operating system with specially designed stream buffers, polling systems interfacing with network interface cards and multiple threads to deliver high performance, high bandwidth packets through the kernel to applications.

The subject matter further relates to a system and method for capturing, aggregating, pre-analyzing and delivering packets to user space within a Linux kernel to be primarily used by intrusion detection systems at multi-gigabit line rate speeds. Background

With multi-gigabit network segments now fairly ubiquitous, evaluating the most effective and efficient means to secure your network can present challenges. Challenges range from extremely costly systems with proprietary ASIC and FPGA hardware components, to highly inefficient systems with traditional open-source and commodity servers. A further challenge relates to the administrative burden in evaluating, deploying, and managing a solution.

Currently, the majority of vendors resell or re-package existing applications loaded on inadequate hardware, call it a ‘security appliance’ and sell it for a premium. Moreover, there are vendors who provide expensive FPGA and ASIC technologies, but are unable to provide efficiencies beyond Layer 2.

There are a number of issues that affect how security appliances and/or security software operate in any given environment. The most significant and obvious issue is whether or not the hardware portion of the solution is capable of handling its task. A 100 Mbit Ethernet card cannot typically capture traffic on a 10 Gbps link. Likewise, the processing power needs to scale linearly with the amount and type of traffic being analyzed. A single processor system cannot typically effectively process 10 Gbps in real-time.

These challenges don't take into account the complex nature between the hardware, operating system, and user applications. Many of today's software is designed and geared toward the lowest common denominator in terms of broad system support. Having a large supported hardware and operating system support base is good for business. However, this isn't always best for effectively solving a problem at hand.

If one is to design a cost effective solution that can handle extremely high throughput rates, one must be cognizant of the fact that major modifications to operating system kernels, optimizations to device drivers, and significant modification to userland programs will be required.

Through a basic understanding of the issues surrounding performance, addressing specifically how the operating system and the security software/application itself are critical paths.

The operating system needs to be able to effectively schedule and manage the underlying hardware properly—via kernel mechanisms and device driver interaction. If the operating system or kernel itself is not designed for effective multi-processor handling and awareness, then performance will suffer as a result of cache misses, deep copies and high bandwidth consumption along the bus due to inter-processor communications.

The operating system is also responsible for providing the facility for packet capture. The existing mechanisms for packet capture within operating systems is poor at best when it comes to high throughput packet capture. Typically, nearly three-quarters of all packets are dropped before they even enter the kernel itself.

In typical security software, once the operating system has the packets, it must then pass the packet, via a deep copy, to the userspace program. This consumes memory, bandwidth, and processor time and takes away precious time from the system where it could be processing and analyzing data.

There are several areas where the present invention would address real-world issues today. These include but are not limited to:

An IDS/IPS (intrusion detection system/intrusion prevention system) typically experiences and is limited by the previously stated problems. The goal of an intrusion detection system is to capture, analyze and alert on attempts of unauthorized access and/or unauthorized software installations such as root kits. The IDS portion of the device is an application which sits in userland space and which typically utilizes standard libraries to receive it's packets. The device must typically pull packets off the wire and then copy them through the kernel space and then to userland space. Handling and inspecting every packet is a CPU intensive process and consumes memory. Typical IDS evasion techniques focus on overwhelming the system with large amounts of packets and then slipping a malicious packet to the target while the IDS is left continually trying to catch up, thereby dropping packets.

A similar situation is experienced with EPS (extrusion prevention systems) whereby more intensive computing power is required. To be effective, an EPS is typically required to analyze every packet leaving a specified network. This analysis must be performed on the whole packet as opposed to known locations within a packet that is typical for an IDS. Deep packet inspection consumes enormous resources as it has to capture each packet flowing out of the network, for every device, then deconstruct each packet and inspect each packet.

Voice over Internet Protocol (VOIP)—The cost advantages of VOIP implementation have been well documented in the industry. Given the increase in deployments of VOIP in government, commercial industry and end user development, the issues surrounding security of VOIP have been documented. Several issues persist:
a. Many consider the most serious threat to VoIP is a distributed denial of service (DoS) attack. It can affect any internet-connected device and works by flooding networks with spurious traffic or server requests. The attack is generated by machines that have been compromised by a virus or other malware and the massive increase in traffic means the affected servers are unable to process any valid requests and the whole system grinds to a halt.
b. The next area of VOIP network vulnerabilities is the danger of spam over internet telephony, or spit. Spam, unsolicited commercial and malicious email spam now makes up the majority of email worldwide. The issue here is that VoIP is destined to suffer the same fate. Certainly spammers wield enough power and are likely to be enthusiastic adopters of a new voice channel to spread their message. The issue with VoIP spam is that email anti-spam methods will not work in the VOIP network environment. A normal content filter typically will not work. Additionally, the potential threat posed by spit is driving vendors to develop alternative anti-spam solutions.
c. Fraud—The biggest concern for business is probably going to be premium-rate fraud, where a criminal hacks into the VoIP system and makes calls to a premium rate number. This fraud is not new and PBXs have always been vulnerable to these hacks. The difference is that few people could hack into PBXs, compared to the many actively breaking into IP systems.

### SUMMARY OF INVENTION

The present subject matter generally relates to computer operating systems, network interface cards, polling systems, central processing units, random access memory and multi-threaded applications.

The present invention relates to a much more efficient buffering system that allows multiple applications direct access to lower level code, while reducing memory usage via inefficient packet copies and reducing context switching, thus lowering CPU usage.

This invention pushes various processes that are currently handled by the application in user space down into the Kernel, which offloads the CPU intensive processing into a more efficient space. This method frees the application to perform its essential functions rather then trying to keep up with copying packets, sorting them and only then beginning its essential functions.

The invention then can be considered to contain but is not limited to the following;

In a first embodiment, the present invention comprises a unique polling mechanism that separates the poll into two DMA calls; the first call fetches the headers of the packets in order to determine the flow subring to send the packet to, the second call directs the packet to the selected flow subring.

In a second embodiment, the present invention comprises a method of dynamically creating a flow ring with a series of multi flow subrings. This allows a push of what is usually a CPU intensive process in userland space down into the kernel space at the time of packet capture.

In a third embodiment, the present invention comprises a multi-threaded “Flow Aggregator” which defragments each flow subring, for example, to sort them into their correct sequences within their flow subring, and then maps them directly into userland space.

In a fourth embodiment, the present invention comprises an API for delivery to the application of a logical grouped set of packets to be processed by the applications functions.

The invention will perform only the most essential activities within kernel space such as packet capturing at the device/interrupt level (known as the bottom half) and packet data storage and manipulation at the kernel level (known as the top half).

This will be performed by implementing and utilizing numerous dynamic circular packet buffers to which the incoming packets are stored when pulled from the network interface card. These dynamic circular packet buffers are also configured in a way to make optimal use of multi-CPU systems in that scheduling of the operations being performed on these packet buffers has been optimized to allow for parallel processing. This is important because a further breakdown of the packet buffers is provided in the concept of a flow thread.

The invention will perform packet processing in a reverse stack implementation, in the case of DoS flood attack of the system itself, to prevent the CPU from being completely consumed: packets first entering have a higher priority, so in case of a DoS or flood, packets will be purposefully dropped and/or discarded, but packets not associated with this activity will continue to be received.

The device driver is the component of the invention that provides an efficient packet reception and transfer mechanisms as well as polling algorithms that query the network interface hardware based on patterns of learning with respect to timing, data transfer rate, and data buffer capacity. The device driver is implemented within the bottom half of the Linux kernel and serves to optimize the efficiency between the actual network interface card hardware and the operating system.

FIG. 1 is a block diagram of what consists of and is hereby defined and referred to as the lower half modifications. FIG. 1 describes the method of dynamically assigned Poller algorithms in conjunction with the Primary flow selection logic. As will be described later, the Poller makes calls into the DMA (direct memory access) bus and the network interface card.

The Pollers take into account multiple processors and load balance the work accordingly. The process is broken up into two processes, which are essentially: a packet poll, and a flow poll. Different CPU contexts are used to accommodate and simultaneously direct these polls.

The Packet poll, also called the fast phase poll, selects the packet and slots it for a particular flow subring based on a hash table by ports and addresses. By performing the fast phase flow control at the time of hardware polling; delays caused by the copying of packets from the packet buffer into a flow buffer are eliminated. In essence the particular packet is tagged or preselected as the packet is being mapped from the NIC buffer. This has created an exceptional performance boost from a memory space allocation perspective and lower utilization of the CPU.

After the fast phase poll, comes the slow phase poll. This phase of flow control works on the massive number for flow ring buffers structured from the slow phase poll. These flow buffers, that contain packets relating to particular flows are sorted by flows at this point and are in no definable order.

The methods defined up to this point allows us to take a commodity Network Interface Card; for example, an Intel Pro 1000, and through kernel level modifications to the driver using DMA (direct memory access) techniques, free the CPU's from spending their time copying packets from the NIC to the kernel and then to userspace.

Looking at a subset of packets, for example, 100 packets associated with 10 flows, the NIC buffer has been polled and has directly mapped and grouped or queued packets directly into 10 flow subrings, with little CPU context switching and interaction.

At this point the Flow/Session Aggregator works on the flow subrings. Within each particular flow subring, the packets are defragmented and are re-sorted into their original or normal state of a communication flow.

In the per thread flow aggregation, the present invention does not allow the processing of protocols/flows from different flow threads. In effect, each flow is segmented from any other, so in case of a flood we can isolate the specific flow thread and take action so as not to allow a DoS style attack of the system. This is a tremendous advantage to protecting the device itself when used as an intrusion detection system. Our ‘slow dissector’ will be isolated from fast and full attacks, such as shellcode and scan detectors.

### BRIEF DESCRIPTION OF DRAWINGS

The drawings depict several methods of implementation

FIG. 1 is a schematic illustration of the Polling system and Primary Flow Selector independent of its connections.

FIG. 2 is a schematic illustration of the circular reverse stack buffering system independent of its connections

FIG. 3 is a schematic illustration of the Flow/Session Aggregator in conjunction with the defragmentation threads. This figure also shows the process of delivering to the API.

FIG. 4 is a schematic illustration of what one embodiment relating to an operating system as a whole looks like with unspecified application written to take advantage of the present invention's performance capabilities.

FIG. 5 is a schematic illustration of an embodiment relating to an intrusion detection system.

FIG. 6 is a schematic illustration of an embodiment relating to an extrusion prevention system.

FIG. 7 is a schematic illustration of an embodiment relating to a traffic load balancer.

### DETAILED DESCRIPTION OF PREFERRED EMBODIMENTS

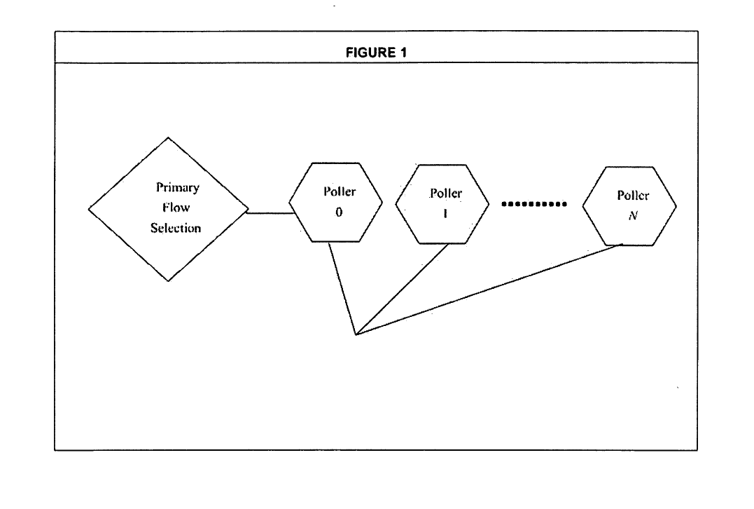

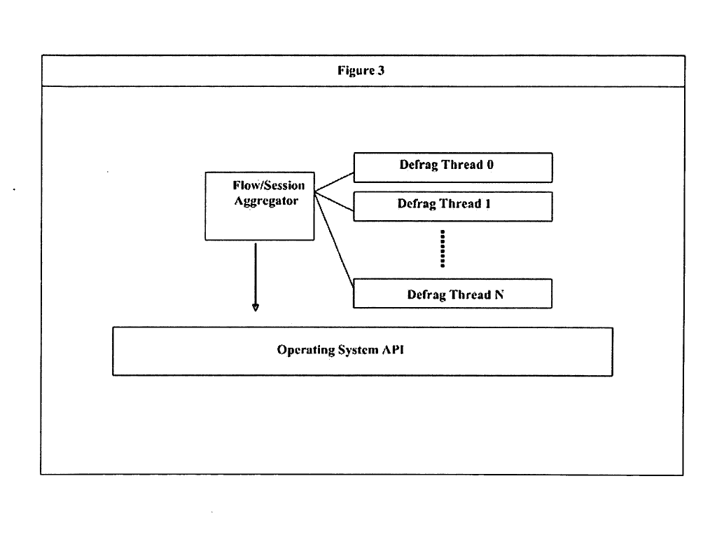

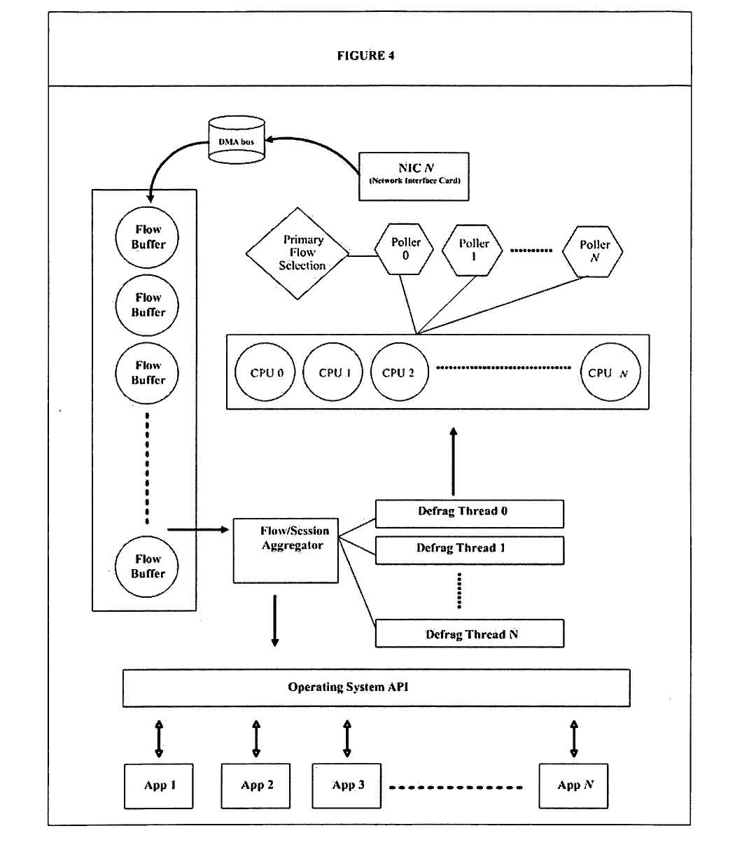

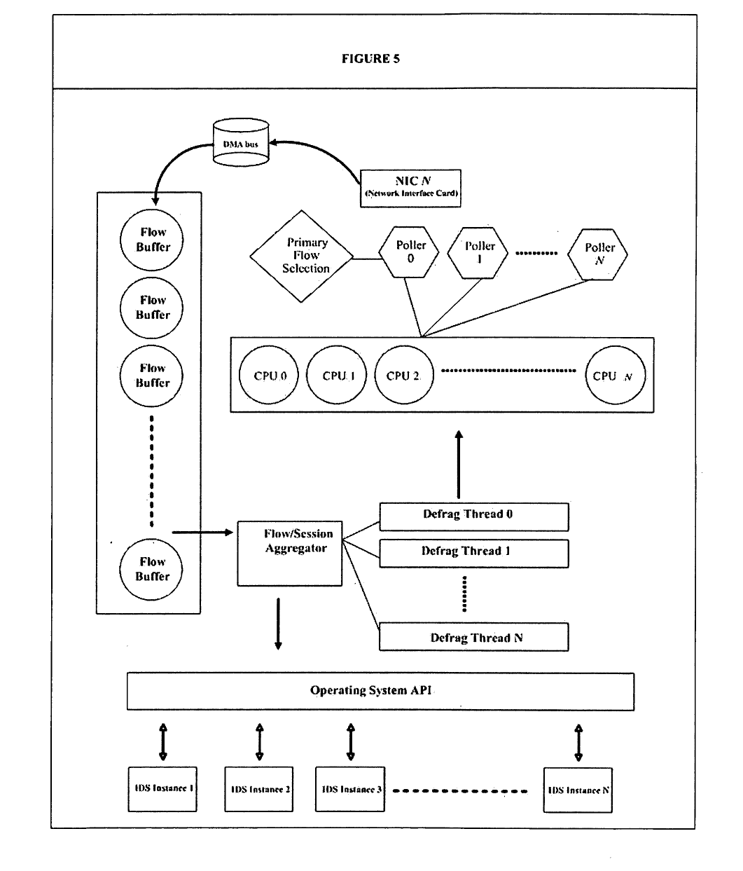

FIG. 5 illustrates an embodiment generally relating to an intrusion detection system. The Poller will pull the packets from the NIC and in conjunction with the Primary Flow Selection process will direct packets into individual flow subrings based on established tuples. The Flow Aggregator then delivers to the API a set of flows based on a tuple whereby an intrusion detection system can access these flows to inspect and analyze them efficiently with some of the heavy lifting of sorting random packets into a group/flow, ordering them into their proper sequences so the IDS can apply the correct context to the communication. The invention in FIGS. 1, 2, 3 and 4 collectively allows multiple instances of an IDS to be run with different configurations. In essence, the present invention allows an IDS to act like a distributed system in that each instance can concentrate on a different subset of attacks.

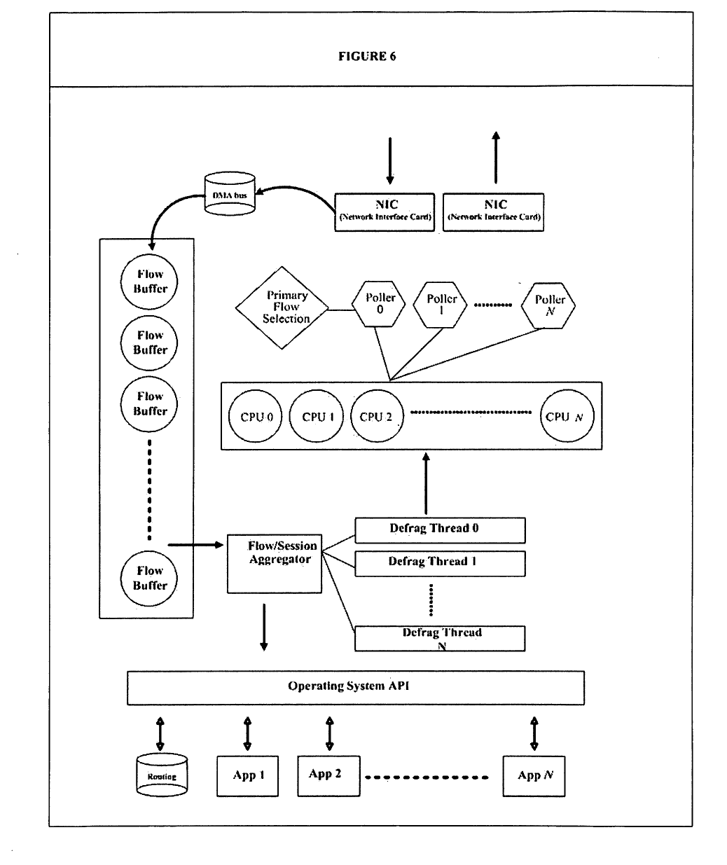

FIG. 6 illustrates an embodiment generally relating to an extrusion detection system only acting on traffic heading out of a specific enclave. While similar to the IDS, various solutions can be applied where roles are defined and based on those roles, specific actions or files may or may not be allowed. When a rule is triggered, several actions may be taken such as; alerts are generated, the packets are dropped and/or recorded, or all of the above. For example, company A may be in the business of research and development and have specific standard operating procedures that do not allow file transmission outbound other then weekly reports averaging 500 Kbytes using ftp. Accordingly, the invention could easily inspect each flow to calculate the determined size of an ftp flow, which would trigger alerts as an ftp session as it neared the threshold and drop all subsequent packets upon reaching the threshold.

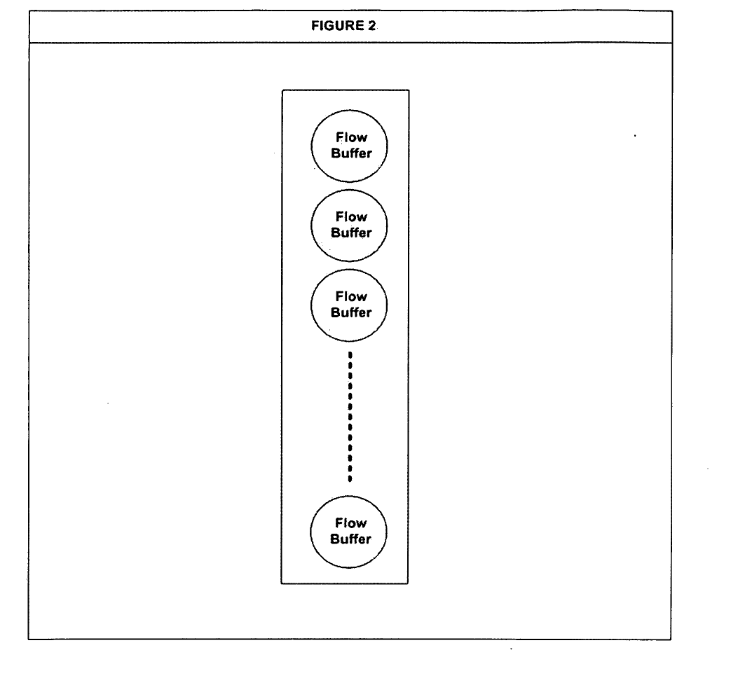

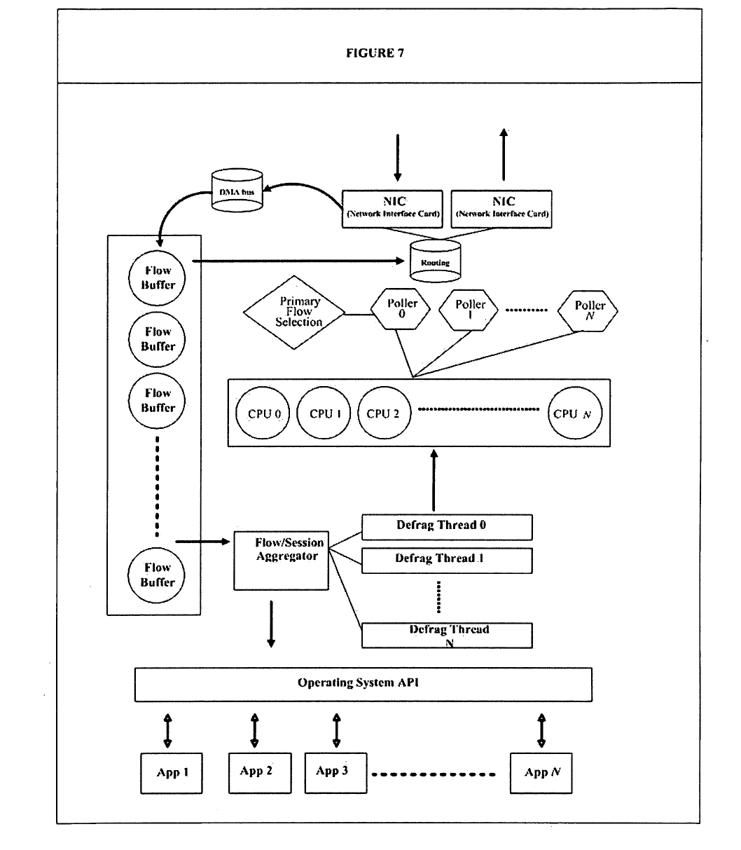

In FIG. 7 the invention is shown relating to traffic load balancing or shaping. As the present invention processes high bandwidth packets efficiently in the Kernel level and separate into flows based on tuples before reaching the application, fine grain control logic and mechanisms can be applied to the flows. An example would be a high profile web site that has multiple servers that may send and receive large amounts of data. The application can be modified to utilize the invention's efficiencies of pre-selecting and grouping flows into a their distinct containers. By analyzing the size of each flow, greater efficiencies can be realized across the mirrored servers. Illustrated in FIG. 2, the ability to prevent Denial of Service attacks against web sites is mitigated by being able to automatically drop packets destined for a determined malicious flow.

Another embodiment for the utilization of the present invention for the purposes of providing higher levels of IP security, include but is not limited to the VOIP telecommunications world.
1. Illustrated in the sections above regard Denial of Service attacks and in FIG. 2, the ability for VOIP applications to integrate with the invention is defined through an API. Whether the attack originates from within or outside the network, the present invention associated with DoS for VOIP application services provides for a security mechanism to defend against an attack addressing a QoS issue for the provider of the VOIP service.
2. Spam and Spit—FIG. 5 illustrates the ability to allow for VOIP to determine the security correctness of a VOIP transaction, specifically protecting against SPAM and SPIT. One example is the reception of a VOIP call to a user. If the call is a suspect call, the VOIP PBX may be forwarded to an automated system that uses a ‘Turing test’ to identify whether a caller is a human or a machine. This involves playing an announcement and detecting whether the caller tries to speak over it, for example. This further requires processes to be defined, engineered, and implemented, which requires staff, overhead and is usually static. Other approaches would be to only allow particular callers through by having the system determine the caller's identity but this could fall victim to spoofing. Implementation of the present invention would allow most of the engineering not to be required, would be automated, and would be dynamic in nature.
3. Associated with Spam is phishing. Though they are likely to be more of a menace to consumers than to businesses, fraud techniques relating to email phishing could be used in voice calls. There is the potential for massive fraud in the early days of voice phishing simply because users still trust telephone messages more than emails. There have already been some clever phishing attacks that use a combination of email and voice to lend credibility to a scam. In the same fashion which DoS is protecting, these techniques could be thwarted with the implementation of this invention.

Another embodiment allows for the increased throughput and capacity of any network software appliance, including but not limited to VOIP applications. As described above, FIG. 7 addresses the ability to increase throughput and capacity of a network appliance without the need to add hardware acceleration against the network, or the need to re-engineer an application moving it to Symmetrical Multi-Processing on proprietary and expensive platforms. The present invention allows for the ability to increase the network throughput of IP software appliances, including by not limited to VOIP servers, without the need for increased hardware costs and re-engineering of the application.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system comprising:
a polling mechanism that separates a poll into a first call and a second call, whereby the first call fetches headers of packets to determine a flow subring to send the packet to and further wherein the second call directs the packets to selected flow subrings.

2. A method comprising:
dynamically creating a flow subring with a series of multiflow subrings.

3. A multi-threaded flow aggregator, wherein said flow aggregator defragments each flow subring, wherein said flow aggregator further sorts packets into their correct sequences within their assigned flow subring and further maps said packets into userland space.
